(19) United States
(12) Patent Application Publication
(10) Pub. No.: US 2009/0140952 A1
(43) Pub. Date: Jun. 4, 2009

(54) Plasma display device, power supply thereof and associated methods

(76) Inventors: Hung-Soo Youn, Suwon-si (KR); Sang-Gu Lee, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/292,768

(22) Filed: Nov. 25, 2008

(30) Foreign Application Priority Data
Nov. 26, 2007 (KR) 10-2007-0120986

(51) Int. Cl. G09G 3/28

(52) U.S. Cl. 345/60

(57) ABSTRACT

A plasma display device includes a scan electrode, a scan circuit configured to selectively apply a first voltage through a first input terminal and a second voltage, lower than the first voltage, through a second input terminal to the scan electrode during an address period, a transformer including a primary coil and a secondary coil, a capacitor including a first terminal and a second terminal respectively connected to the first input terminal and the second input terminal, the capacitor being charged with a third voltage corresponding to a difference between the first voltage and the second voltage in accordance with a current transmitted to the secondary coil, and a first switch connected between the second input terminal and a power source configured to supply the second voltage.

### BACKGROUND OF THE INVENTION

1. Field of the Invention

Embodiments relate to a plasma display device, a power supply device thereof, and associated methods.

2. Description of the Related Art

A plasma display device is a display device that uses a plasma display panel (PDP) for displaying characters or images using plasma that is generated by a gas discharge. The PDP includes, depending on its size, more than several scores to millions of discharge cells (hereinafter, simply called “cells”) arranged in a matrix pattern. The plasma display device generally divides a frame into a plurality of respectively weighted subfields for driving and displaying an image.

Each subfield typically includes an address period and a sustain period. In the address period, a cell to be turned on or a cell not to be turned on is selected by sequentially applying a scan pulse to a plurality of scan electrodes. In the sustain period, a sustain discharge is performed in a cell to be turned on in order to display an image by alternately applying a high level voltage and a low level voltage of a sustain discharge pulse to sustain electrodes for performing a sustain discharge.

A power source unit generates a plurality of voltages applied to the plurality of scan electrodes, and the plurality of voltages is applied to the scan electrodes by a scan electrode driver. Elements having similar functions are used in the power source unit and the scan electrode driver. However, the power source unit and scan electrode driver are implemented separately. Therefore, a circuit configuration of the power source unit and scan electrode driver is complicated, and a manufacturing cost is problematically increased.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments are therefore directed to a plasma display device, a power supply device thereof, and associated methods, which substantially overcomes one or more of the problems and disadvantages of the related art.

It is therefore a feature of an embodiment to provide a plasma display device and a power supply device thereof having a simpler circuit configuration.

It is therefore another feature of an embodiment to provide a plasma display device and a power supply device thereof that may be manufactured more cheaply.

It is yet another feature of an embodiment to provide a plasma display device, a power supply device thereof, and associated methods that may maintain a capacitor at a predetermined voltage.

At least one of the above and other features and advantages may be realized by providing a plasma display device including a scan electrode, a scan circuit, a transformer, a capacitor, and a first switch. The scan circuit is configured to selectively apply a first voltage through a first input terminal and a second voltage, lower than the first voltage, through a second input terminal to the scan electrode during an address period. The transformer includes a primary coil and a secondary coil. The capacitor includes a first terminal and a second terminal respectively connected to the first input terminal and the second input terminal, the capacitor being charged with a third voltage corresponding to a difference between the first voltage and the second voltage in accordance with a current transmitted to the secondary coil. The first switch is connected between the second input terminal and a power source, and is configured to supply the second voltage.

At least one of the above and other features and advantages may be realized by providing a power supply device of a plasma display device having a scan circuit. The scan circuit is configured to selectively apply a first voltage through a first input terminal and a second voltage, lower than the first voltage, through a second input terminal to a scan electrode. The power supply device includes a transformer, a capacitor, a first switch, and a switch controller. The capacitor includes a first terminal and a second terminal respectively connected to the first input terminal and the second input terminal, the capacitor being charged with a third voltage corresponding to a difference between the first voltage and the second voltage in accordance with a current transmitted to the secondary coil. The first switch is connected to the primary coil. The switch controller is configured to control an on/off time of the first switch so that the voltage charged in the capacitor is maintained at the third voltage.

At least one of the above and other features and advantages may be realized by providing a method of providing voltages to a scan electrode of a plasma display device, the method including selectively applying a first voltage through a first input terminal and a second voltage, lower than the first voltage, through a second input terminal to the scan electrode during an address period, charging a capacitor including a first terminal and a second terminal respectively connected to the first input terminal and the second input terminal with a third voltage corresponding to a difference between the first voltage and the second voltage in accordance with a current transmitted to a secondary coil of a transformer, and controlling on an/off a first switch connected to the primary coil of the transformer so that the voltage charged in the capacitor is maintained at the third voltage.

### BRIEF DESCRIPTION OF THE DRAWINGS

The above and other features and advantages will become more apparent to those of ordinary skill in the art by describing in detail exemplary embodiments thereof with reference to the attached drawings, in which:

FIG. 1 illustrates a block diagram of a plasma display device according to an exemplary embodiment of the present invention;

FIG. 2 illustrates a driving waveform of the plasma display device according to the exemplary embodiment of the present invention;

FIG. 3 illustrates a block diagram of a power source unit;

FIG. 4 illustrates a diagram of a VscH voltage generator and a scan electrode driver according to a first exemplary embodiment of the present invention;

FIG. 5 illustrates a diagram of a VscH voltage generator and a scan electrode driver according to a second exemplary embodiment of the present invention; and

FIG. 6 illustrates a diagram of a VscH voltage generator according to a third exemplary embodiment of the present invention and the scan electrode driver.

### DETAILED DESCRIPTION OF THE INVENTION

Korean Patent Application No. 10-2007-0120986, filed on Nov. 26, 2007, in the Korean Intellectual Property Office, and entitled: “Plasma Display Device and Power Supply Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art. Like reference numerals may refer to like elements throughout.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

The wall charges described in the present specification are charges formed on a wall (e.g., a dielectric layer) close to each electrode of a discharge cell. The wall charges will be described as being “formed” or “accumulated” on the electrode, although the wall charges do not actually touch the electrodes. A wall voltage is a potential difference formed on the wall of the discharge cell by the wall charges.

A plasma display device according to exemplary embodiments of the present invention and a driving method thereof will be described.

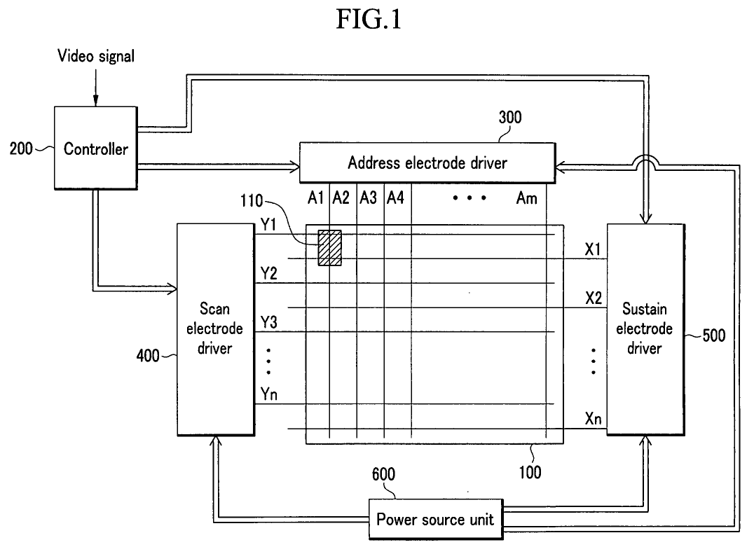

FIG. 1 illustrates a block diagram of a plasma display device according to an exemplary embodiment of the present invention.

As shown in FIG. 1, the plasma display device according to an exemplary embodiment of the present invention may include a plasma display panel (PDP) 100, a controller 200, an address electrode driver 300, a scan electrode driver 400, a sustain electrode driver 500, and a power source unit 600.

The PDP 100 may include a plurality of address electrodes A1 to Am (hereinafter referred to as “A electrodes”) extending in a column direction, and pluralities of sustain and scan electrodes X1 to Xn and Y1 to Yn (hereinafter respectively referred to as “X electrodes” and “Y electrodes”) extending in a row direction in pairs. In general, the X electrodes X1 to Xn are formed corresponding to the Y electrodes Y1 to Yn, respectively. The X electrodes and Y electrodes perform a display operation for displaying an image in a sustain period. The Y electrodes Y1 to Yn and the X electrodes X1 to Xn may cross the A electrodes A1 to Am. Discharge spaces at crossing regions of the A electrodes A1 to Am and the X and Y electrodes X1 to Xn and Y1 to Yn form cells 110. This is an example structure of the PDP 100, and embodiments are applicable to other PDP structures.

The controller 200 may receive an external video signal, and output an A electrode driving control signal, an X electrode driving control signal, and a Y electrode driving control signal. In addition, the controller 200 may divide one frame into a plurality of subfields and may drive the subfields. Each subfield may include a reset period, an address period, and a sustain period.

The address electrode driver 300 may receive the A electrode driving control signal from the controller 200 and may apply a display data signal for selecting a desired discharge cell to the A electrode. The scan electrode driver 400 may receive the Y electrode driving control signal from the controller 200 and may apply a driving voltage to the Y electrode. The sustain electrode driver 500 may receive the X electrode driving control signal from the controller 200 and may apply the driving voltage to the X electrode. The power source unit 600 may generate voltages for driving the PDP 100 and supply the voltages to the respective drivers 300, 400, and 500.

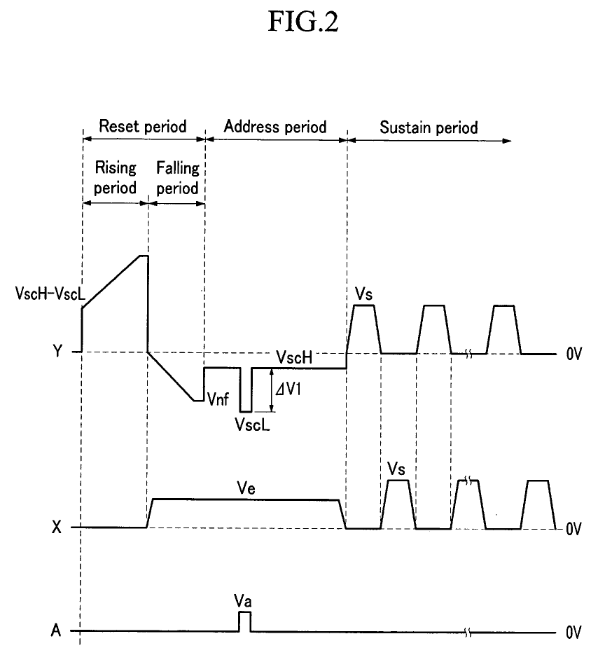

FIG. 2 illustrates a diagram of a driving waveform of the plasma display device according to an exemplary embodiment of the present invention. For convenience of description, the driving waveform applied to the Y, X, and A electrodes forming one cell will be described in FIG. 2.

During a rising period of a reset period, voltages of the X electrode and the A electrode may be maintained at a reference voltage (0V in FIG. 2), and a voltage of the Y electrode may be gradually increased from a voltage of (VscH−VscL) to a voltage of (Vset+(VscH−VscL)). While the voltage of the Y electrode increases, a weak reset discharge is generated between the Y electrode and the X electrode, and wall charges are formed in a discharge cell.

During a falling period of the reset period, the voltages of the A electrode and the X electrode may be maintained at the reference voltage and a Ve voltage, respectively, the voltage of the Y electrode may be gradually decreased from the voltage of (Vset+(VscH−VscL)) to a Vnf voltage. While the voltage of the Y electrode decreases, weak discharge is generated between the Y and X electrodes and the Y and A electrodes. In addition, wall charges formed on the discharge cell are eliminated, thereby initializing the discharge cell as a non-light-emitting cell. In general, a voltage of (Vnf−Ve) may be close to a discharge firing voltage Vfxy between the Y electrode and the X electrode. Thus, a wall voltage between the Y and X electrodes may be close to 0V. Therefore, a cell in which an address discharge is not generated in the address period may be prevented from being misfired during the sustain period.

During the address period, to select a turn-on discharge cell, while the Ve voltage is applied to the X electrode, a scan voltage having a VscL voltage may be sequentially applied to the plurality of Y electrodes. A Va voltage may be applied to the A electrode passing through a discharge cell to be emitted among the plurality of discharge cells formed by the X electrode and the Y electrode to which the VscL voltage is applied. Thereby, the address discharge is generated between the A electrode receiving the Va voltage and the Y electrode receiving the VscL voltage, and between the Y electrode receiving the VscL voltage and the X electrode receiving the Ve voltage. A VscH voltage that is higher than the VscL voltage may be applied to the Y electrode to which the VscL voltage is not applied, and the reference voltage may be applied to the A electrode of the discharge cell that is not selected.

In addition, to perform the above operation during the address period, the scan electrode driver 400 may select the Y electrode to which the scan pulse having the VscL voltage is applied from among the Y electrodes Y1 to Yn. For example, in a single driving mode, the Y electrodes may be selected in a vertically arranged Y electrode order. When one Y electrode is selected, the address electrode driver 300 may select a turn-on discharge cell among the discharge cells formed by the corresponding Y electrode. That is, the address electrode driver 300 may select the A electrode to which the address pulse of the Va voltage is applied from among the A electrodes.

During the sustain period, a sustain pulse having a high level voltage (a Vs voltage in FIG. 2) and a low level voltage (the 0V voltage in FIG. 2) may be applied to the Y electrode and the X electrode. In this case, the sustain pulse applied to the Y electrode may have an opposite phase to that of the X electrode, such that the Vs voltage is applied to the Y electrode while the 0V voltage is applied to the X electrode, and vice versa. Thus, a sustain discharge is generated between the Y electrode and the X electrode, and negative (−) wall charges and positive (+) wall charges are respectively formed on the Y electrode and the X electrode by the sustain discharge. Hereinafter, an operation for applying the sustain pulse to the Y electrode and the X electrode is repeatedly performed a number of times corresponding to a weight value of a corresponding subfield. Generally, the sustain pulse has a square wave.

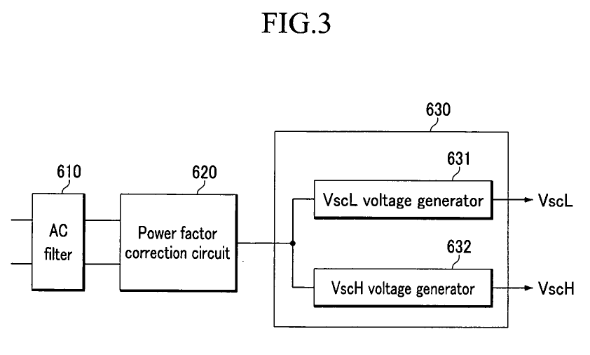

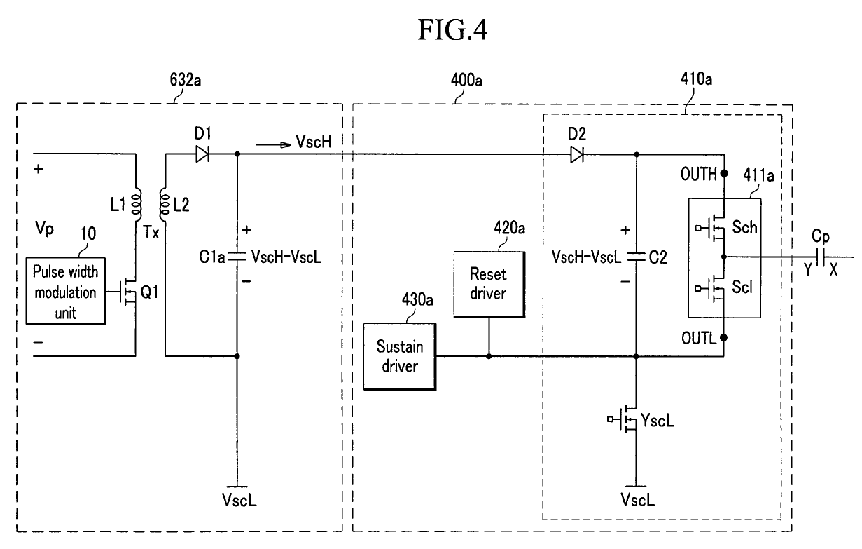

Voltages, including the Vs, Va, VscH, and VscL voltages, applied to the respective X, Y, and A electrodes may be generated and supplied by the power source unit 600. A configuration and an operation of the power source unit 600 will now be described with reference to FIG. 3 and FIG. 4.

FIG. 3 illustrates a block diagram of the power source unit 600. As shown in FIG. 3, the power source unit 600 may be a switching mode power supply including an AC filter 610, a power factor correction circuit 620, and a voltage generator 630.

The AC filter 610 may filter an externally input AC voltage to eliminate noise. The power factor correction circuit 620 may receive the AC voltage from the AC filter 610, compensate a power factor, and output it as a DC voltage. The voltage generator 630 may include a plurality of DC-DC converters including a VscL voltage generator 631 and a VscH voltage generator 632. The VscL voltage generator 631 and the VscH voltage generator 632 may receive the DC voltage from the power factor correction circuit 620, and may respectively generate voltages corresponding to the VscL voltage and the VscH voltage.

In FIG. 3, the voltage generator 630 includes two voltage generators, but the voltage generator 630 may include additional voltage generator(s) for generating additional voltage(s).

The VscH voltage generator 632 and the scan electrode driver 400 will now be described with reference to FIG. 4 to FIG. 6. In FIG. 4 to FIG. 6, a circuit for generating and supplying the VscH voltage is illustrated among circuits of the scan electrode driver 400 and the power source unit 600. In addition, in FIG. 4 to FIG. 6, a transistor used in the scan electrode driver 400 is illustrated as an n-channel transistor, but the transistor may be a field effect transistor (FET) having a body diode, or various transistors for performing the same or similar functions. A capacitive component formed by the X electrode and the Y electrode is illustrated as a panel capacitor Cp.

Before describing the VscH voltage generator 632 and the scan electrode driver 400 according to exemplary embodiments of the present invention, a conventional VscH voltage generator 632a and a conventional scan electrode driver 400a will now be described with respect to FIG. 4.

FIG. 4 illustrates a diagram of the VscH voltage generator 632a and the scan electrode driver 400a according to a first exemplary embodiment of the present invention. As shown in FIG. 4, the VscH voltage generator 632a includes a transformer Tx (L1, L2), a transistor Q1, a pulse width modulation unit 10, a diode D1, and a capacitor C1a.

A first terminal of a primary coil L1 of the transformer Tx is connected to an output terminal of the power factor correction circuit 620 and a second terminal thereof is connected to a drain terminal of the transistor Q1. A source terminal of the transistor Q1 is connected to a ground, and a gate terminal thereof is connected to an output terminal of the pulse width modulation unit 10. A first terminal of a secondary coil L2 of the transformer Tx is connected to an anode of the diode D1. A cathode of the diode D1 is connected to a first terminal of the capacitor C1a, and a second terminal of the capacitor C1a is connected to a VscL power source for supplying the VscL voltage. When the transistor Q1 is turned on, a current flows to the primary coil L1 of the transformer Tx by an output voltage Vp of the power factor correction circuit 620. Therefore, a current flows to the secondary coil L2. The current flowing to the secondary coil L2 is transmitted to the capacitor C1a through the diode D1 to charge a voltage in the capacitor C1a. In this case, the pulse width modulation unit 10 controls a turn-on time of the transistor Q1 so that a voltage ΔV1 (i.e., a voltage of (VscH−VscL)) is charged in the capacitor C1a. In addition, since a second terminal of the capacitor C1a is connected to the VscL power source, the VscH voltage is supplied to the scan electrode driver 400a through a first terminal of the capacitor C1a and an output terminal of the VscH voltage generator 632a.

The scan electrode driver 400a includes a scan driver 410a, a reset driver 420a, and a sustain driver 430a. The scan driver 410a includes a scan circuit 411a, a capacitor C2, a diode D2, and a transistor YscL.

An anode of the diode D2 is connected to an output terminal of the VscH voltage generator 632a, and a cathode thereof is connected to a node of a first terminal of the capacitor C2 and the scan circuit 411a. A second terminal of the capacitor C2 is connected to a node of the scan circuit 411a and the transistor YscL.

The scan circuit 411a has a first input terminal OUTH and a second input terminal OUTL, and an output terminal thereof is connected to the Y electrode. To select a turn-on cell during the address period, a voltage of the first input terminal OUTH and a voltage of the second input terminal OUTL are selectively applied to the corresponding Y electrodes. One scan circuit 411a connected to one Y electrode is illustrated in FIG. 4, and a plurality of scan circuits are respectively connected to the plurality of Y electrodes Y1 to Yn. In addition, a predetermined number of scan circuits are formed as one scan integrated circuit (IC), and a plurality of output terminals of the scan IC may be respectively connected to a predetermined number of Y electrodes.

The scan circuit 411a includes transistors Sch and Scl. A source of the transistor Sch and a drain of the transistor Scl are connected to the Y electrode. A drain of the transistor Sch is connected to the output terminal of the VscH voltage generator 632a for outputting the VscH voltage through the diode D2. A source of the transistor Scl is connected to a drain of the transistor YscL. The source of the transistor Scl is connected to a power source VscL for supplying the VscL voltage. When the transistor YscL is turned on, the voltage ΔV1 (i.e., a voltage of (VscH−VscL)) is charged in the capacitor C2.

In addition, the reset driver 420a and the sustain driver 430a are connected to the second input terminal OUTL of the scan circuit 411a. The reset driver 420a applies a waveform for generating the reset discharge in the Y electrode through the scan circuit 411a during the reset period of each subfield. The sustain driver 430 applies the sustain pulse to the Y electrode through the scan circuit 411a during the sustain period of each subfield.

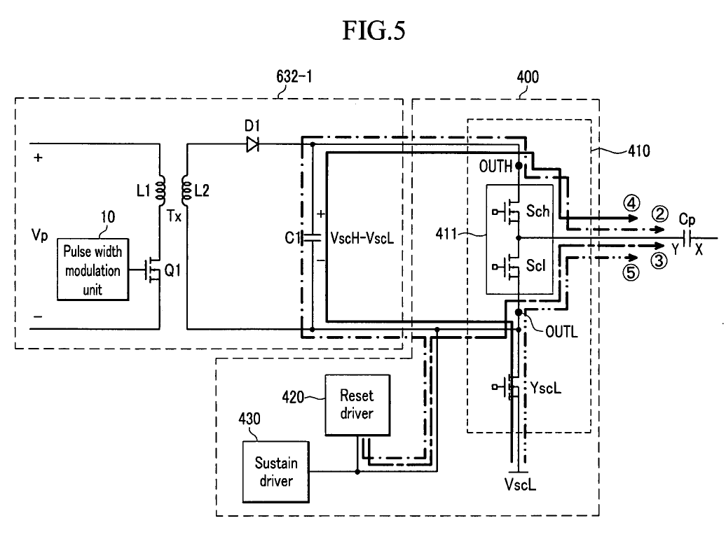

FIG. 5 illustrates a diagram of a VscH voltage generator 632-1 and the scan electrode driver 400 according to a second exemplary embodiment of the present invention. Only differences between the VscH voltage generator 632-1 and the scan electrode driver 400 illustrated in FIG. 5 relative to the VscH voltage generator 632a and the scan electrode driver 400a illustrated in FIG. 4 may be described in detail below.

As shown in FIG. 5, in the VscH voltage generator 632-1, the second terminal of the capacitor C1 may be connected to a second input terminal OUTL of a scan circuit 411. In addition, a reset driver 420 and a sustain driver 430 may be connected to the second input terminal OUTL of the scan circuit 411. Accordingly, in the VscH voltage generator 632-1, the first terminal of the capacitor C1 may supply a voltage that is greater than a voltage of the second input terminal of the scan circuit 411 by the ΔV1 voltage, i.e., the voltage of (VscH−VscL). The scan driver 410 may include the scan circuit 411 and the transistor YscL, while the diode D2 and the capacitor C2 may be omitted as compared with the scan driver 410a shown in FIG. 4. The first input terminal OUTH of the scan circuit 411, i.e., the drain of the transistor Sch, may be connected to the first terminal of the capacitor C1. The second input terminal OUTL of the scan circuit 411, i.e., the source of the transistor Scl, may be connected to the second terminal of the capacitor C1.

Operations of the VscH voltage generator 632-1 and the scan electrode driver 400 will be described with reference to FIG. 2 and FIG. 5.

During the rising period of the reset period, since the transistor Sch is turned on while the 0V voltage is applied to the second terminal of the capacitor C1 by the sustain driver 430, the voltage of (VscH−VscL) is applied to the Y electrode through the capacitor C1 and the transistor Sch. Subsequently, the reset driver 420 may gradually increase a voltage of the second terminal of the capacitor C1 from the 0V voltage to the Vset voltage. Therefore, the voltage of the Y electrode may be gradually increased from the voltage of (VscH−VscL) to the voltage of (Vset+(VscH−VscL)) through a current path \textcircled{2} of the capacitor C1, the transistor Sch, and the Y electrode.

During the falling period of the reset period, since the transistor Scl is turned on while the 0V voltage is applied the second terminal of the capacitor C1 by the sustain driver 430, the 0V voltage is applied to the Y electrode through the transistor Scl. Subsequently, the reset driver 420 may gradually decrease the voltage of the second input terminal OUTL of the scan circuit 411 from the 0V voltage to the Vnf voltage. Therefore, the voltage of the Y electrode may be gradually decreased from the 0V voltage to the Vnf voltage through a current path \textcircled{3} of the transistor Scl and the Y electrode.

During the address period, the transistor Sch and the transistor YscL are turned on when the scan pulse is not applied. Thereby, since the transistor Sch is turned on while the voltage of the second terminal of the capacitor C1 is the VscL voltage, a current path \textcircled{4} of the VscL power source, the capacitor C1, the transistor Sch, and the Y electrode is formed. The VscH voltage is applied to the Y electrode through the current path \textcircled{4}. During a period in which the scan pulse is applied, the transistor Sch is turned off and the transistor Scl is turned on. Thereby, a current path \textcircled{5} of the power source VscL, the transistor Scl, and the Y electrode is formed regardless of the voltage charged in the capacitor C1. The VscL voltage is applied to the Y electrode through the current path \textcircled{5}.

During the sustain period, the transistor Scl is turned on and the transistor YscL is turned off. Thereby, the sustain driver 430 may alternately apply the 0V voltage and the Vs voltage to the Y electrode through the transistor Scl.

Since the capacitor C1 is shared by the power source unit 600 and the scan electrode driver 400, the capacitor C2 for charging the ΔV1 voltage may be omitted from the scan driver 410 of the scan electrode driver 400. In addition, the diode D2 for preventing the voltage charged in the scan electrode driver 400 from inversely flowing to the power source unit 600 may be omitted.

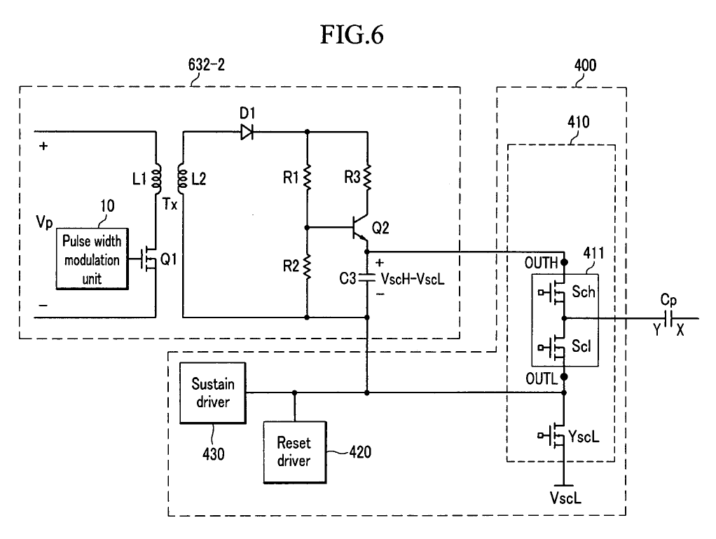

A voltage difference induced to the secondary coil L2 through the transformer Tx may be a ΔV2 voltage that is greater than the ΔV1 voltage. A VscH voltage generator 632-2 for generating the VscH voltage when the voltage difference induced to the secondary coil L2 is greater than the ΔV2 voltage will now be described with reference to FIG. 6.

FIG. 6 illustrates a diagram of the VscH voltage generator 632-2 according to a third exemplary embodiment of the present invention and the scan electrode driver 400.

As shown in FIG. 6, compared to the VscH voltage generator 632a shown in FIG. 4 and the VscH voltage generator 632-1 shown in FIG. 5, the VscH voltage generator 632-2 may further include a plurality of resistors R1, R2, and R3, and a transistor Q2. Here, the transistor Q2 is a bipolar transistor. In addition, the resistors R1, R2, and R3 may be a plurality of resistors coupled in parallel or in series, or may be variable resistors.

A collector of the transistor Q2 may be connected to a second terminal of the resistor R3, and an emitter thereof may be connected to a capacitor C3. The capacitor C3 may have a first terminal connected to the first input terminal OUTH and a second terminal connected to the second input terminal OUTL. A first terminal of the resistor R1 may be connected to a cathode of the diode D1, and a second terminal thereof may be connected to a base of the transistor Q2. A first terminal of the resistor R2 may be connected to the base of the transistor Q2, and a second terminal thereof may be connected to the capacitor C3. The resistor R1 and the resistor R2 may be connected to each other, and a node thereof may be connected to the base of the transistor Q2. A first terminal of the resistor R3 may be connected to the cathode of the diode D1, and the second terminal thereof may be connected to a collector of the transistor Q2.

When a voltage output through the diode D1 is greater than a voltage V_{OUTL} of the second input terminal OUTL of the scan circuit 411 by the ΔV2 voltage, a voltage difference between a voltage (V_{OUTL}+(R2/(R1+R2))*ΔV2) of the node of the resistor R1 and the resistor R2, and a voltage (ΔV1+V_{OUTL}) of the first terminal of the capacitor C3 may be increased to be greater than a threshold voltage. Thereby, a voltage is charged in the capacitor C3. When the voltage difference between the voltage (V_{OUTL}+(R2/(R1+R2))*ΔV2) of the node of the resistor R1 and the resistor R2, and the voltage (ΔV1+V_{OUTL}) of the first terminal of the capacitor C3 is less than the threshold voltage while the voltage is charged in the capacitor C3, the transistor Q2 is turned on. Accordingly, the voltage charged in the capacitor C3 may be maintained at the ΔV1 voltage.

As described, the plasma display device according to the exemplary embodiments of the present invention and the power supply device of the plasma display device have some circuit elements in common. Thus, the number of constituent elements may be reduced, and manufacturing cost may be reduced.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display device, comprising:
a scan electrode;
a scan circuit configured to selectively apply a first voltage through a first input terminal and a second voltage, lower than the first voltage, through a second input terminal to the scan electrode during an address period;
a transformer including a primary coil and a secondary coil;
a capacitor including a first terminal and a second terminal respectively connected to the first input terminal and the second input terminal, the capacitor being charged with a third voltage corresponding to a difference between the first voltage and the second voltage in accordance with a current transmitted to the secondary coil; and
a first switch connected between the second input terminal and a power source configured to supply the second voltage.

2. The plasma display device as claimed in claim 1, further comprising a diode including an anode connected to a first terminal of the secondary coil and a cathode connected to the first terminal of the capacitor, wherein the second terminal of the capacitor is connected to a second terminal of the secondary coil.

3. The plasma display device as claimed in claim 1, further comprising:
a first resistor including a first terminal connected to a first terminal of the secondary coil;
a second resistor including a first terminal connected to a second terminal of the first resistor and a second terminal connected to the second terminal of the capacitor; and
a second switch including a first terminal connected to the first terminal of the secondary coil, a second terminal connected to a node of the first and second resistors, and a third terminal connected to the first terminal of the capacitor,
wherein the second switch is turned on/off according to a voltage difference between a voltage of the node between the first and second resistors and a voltage of the first terminal of the capacitor.

4. The plasma display device as claimed in claim 1, wherein the scan circuit comprises:
a third switch including a first terminal connected to the first terminal of the capacitor and a second terminal connected to the scan electrode; and
a fourth switch including a first terminal connected to the scan electrode and a second terminal connected to the second terminal of the capacitor.

5. The plasma display device as claimed in claim 1, wherein the transformer and the capacitor are part of a switching mode power supply (SMPS) configured to generate the first and second voltages.

6. The plasma display device as claimed in claim 1, wherein a voltage of the first terminal of the capacitor is directly applied to the first input terminal.

7. A power supply device of a plasma display device including a scan circuit configured to selectively apply a first voltage through a first input terminal and a second voltage, lower than the first voltage, through a second input terminal to a scan electrode, the power supply device comprising:
a transformer including a primary coil and a secondary coil;
a capacitor having a first terminal and a second terminal respectively connected to the first input terminal and the second input terminal, the capacitor being charged with a third voltage corresponding to a difference between the first voltage and the second voltage in accordance with a current transmitted to the secondary coil;
a first switch connected to the primary coil; and
a switch controller configured to control an on/off time of the first switch so that the voltage charged in the capacitor is maintained at the third voltage.

8. The power supply device as claimed in claim 7, further comprising a diode including an anode connected to a first terminal of the secondary coil and a cathode connected to the first terminal of the capacitor, wherein the second terminal of the capacitor is connected to a second terminal of the secondary coil.

9. The power supply device as claimed in claim 7, further comprising:
a first resistor including a first terminal connected to a first terminal of the secondary coil;
a second resistor including a first terminal connected to a second terminal of the first resistor and a second terminal connected to the second terminal of the capacitor; and
a second switch including a first terminal connected to the first terminal of the secondary coil, a second terminal connected to a node of the first and second resistors, and a third terminal connected to the first terminal of the capacitor,
wherein the second switch is turned on/off according to a voltage difference between a voltage of the node between the first and second resistors and a voltage of the first terminal of the capacitor.

10. The power supply device as claimed in claim 7, wherein a voltage of the first terminal of the capacitor is directly applied to the first input terminal.

11. A method of providing voltages to a scan electrode of a plasma display device, the method comprising:
selectively applying a first voltage through a first input terminal and a second voltage, lower than the first voltage, through a second input terminal to the scan electrode during an address period;
charging a capacitor including a first terminal and a second terminal respectively connected to the first input terminal and the second input terminal with a third voltage corresponding to a difference between the first voltage and the second voltage in accordance with a current transmitted to a secondary coil of a transformer; and
controlling an on/off a first switch connected to the primary coil of the transformer so that the voltage charged in the capacitor is maintained at the third voltage.

12. The method as claimed in claim 11, further comprising:
turning a second switch on/off according to a voltage difference between a voltage of a node between first and second resistors and a voltage of the first terminal of the capacitor, the second switch having a first terminal connected to the secondary coil, a second terminal connected to the node of the first and second resistors, and a third terminal connected to the first terminal of the capacitor.

13. The method as claimed in claim 11, further comprising directly applying a voltage of the first terminal of the capacitor to the first input terminal.
